(19) United States
(12) Patent Application Publication
(10) Pub. No.: US 2003/0075264 A1
(43) Pub. Date: Apr. 24, 2003

(54) Method for producing a continuous sheet having optical functions

(75) Inventors: Fumiya Terakado, Osaka (JP); Minoru Tsuzuki, Osaka (JP); Takumi Kosugi, Osaka (JP); Shuzo Ohara, Osaka (JP)

Correspondence Address: ARMSTRONG,WESTERMAN & HATTORI, LLP, 1725 K STREET, NW., SUITE 1000, WASHINGTON, DC, 20006, US

(73) Assignee: Goyo Paper Working Co., Ltd., Osaka-shi (JP)

(21) Appl. No.: 09/824,803

(22) Filed: Apr. 4, 2001

(51) Int. Cl. B29C 47/00

(52) U.S. Cl. 156/244.24; 156/289; 156/246

(57) ABSTRACT

A continuous sheet having a three-dimensional pattern providing the optical functions is produced by the use of a release sheet of a curable resin on which the three-dimensional pattern is formed, a change in a surface-gloss of a layer of the release sheet on which the three-dimensional pattern is formed, is not more than 30% in pressing a hot plate heated to 160° C. under a force of 20 kg/cm² for 3 seconds and the release sheet may be wound in a form of cylinder of not more than 12 inches in diameter. In accordance with the present invention, it is possible to enhance a degree of freedom of processing conditions and thermoplastic resins to be used and to produce a continuous sheet having high performance optical functions efficiently.

### BACKGROUND OF THE INVENTION

1. Field of the Invention

The present invention relates to a continuous sheet having optical functions and, more particularly, to a continuous plastic sheet having optical functions such as (light) transmission, refraction, reflection, scattering, interference, polarization and the like, i.e., plastic lens, light reflection sheets, prism sheets, anti-dazzling sheets, diffusion sheets and a combination of such optical effects, which have been imparted by a continuous release sheet having a desired three-dimensional pattern on its surface.

2. Description of the Prior Art

Nowadays, films or sheets utilizing the optical properties of synthetic resin films or sheets (both called “sheet” hereinafter unless otherwise noted) are deeply related with industrial and daily living activities. Most of them, however, have their surface flat, competing merely in transparency of resins, or control ray transmissivity by such as making the surface matte or adding additives.

In recent years, plastic lenses, and optically functional sheets such as prism sheets, anti-dazzling sheets and diffusion sheets as a structural component of liquid crystal displays used for note-type personal computers or liquid crystal TVs, which have special surface structures for adjusting, among others, surface reflectivity, refraction, scattering or combinations thereof have been drawing particular attention.

A sheet with a specific three-dimensional pattern is often made by press molding by the use of an embossed plate having a desired particular three-dimensional pattern or by injection molding. However, these methods are either poor in producibility because of a batch type production or have a problem of not being suitable for the formation of thin sheets. Meanwhile, for the production of a continuous sheet having a three-dimensional pattern, there are such alternatives as extruding through a profile die or using a proper embossing roll for patterning the surface of a sheet, but with these methods it is difficult to impart to the sheet surface a precise pattern for imparting thereto an optical performance and, even if such effect should be attainable, it is only attained partly, thus being inaccurate.

Recently, a method of using a release sheet having a three-dimensional pattern provided with optical functions on a surface has been proposed by Japanese Patent No.2,925,069 and U.S. Pat. No. 5,885,490. In this method, a continuous release sheet having a three-dimensional pattern formed by a metallic embossing roll is used and a desired thermoplastic resin is extruded on this release sheet and the pattern is transferred on the surface of resin, and therefore it is possible to produce a three-dimensional pattern efficiently and continuously without seam and to obtain desired resinous optical products of a thermoplastic resin.

As stated above, in a method of using a continuous release sheet having a three-dimensional pattern being capable of providing optical functions, it is possible to efficiently obtain desired resinous optical products of a thermoplastic resin. Particularly, when a thermoplastic resin is used as a release sheet on which a pattern is formed by a metallic embossing roll, it is favorable since a release sheet of a thermoplastic resin may be produced in the process similar to the following process of producing resinous optical products.

However, the processing temperature in producing resinous optical products is limited within the limitation of heat resistance of the release sheet, and this constraint may interfere with modifications of resins for optical products and further improvements of optical characteristics.

### SUMMARY OF THE INVENTION

It is an object of the present invention to provide a producing method of a continuous sheet of a curable resin which eliminates the drawbacks of a continuous sheet of a thermoplastic resin.

Other objects and advantages of the present invention will become apparent for those skilled in the art from the detailed description given below.

### BRIEF DESCRIPTION OF THE DRAWINGS

FIG. 1 is a schematic sectional view showing a sawtooth pattern in the example of the present invention.

FIG. 2 is a schematic view showing a production apparatus used in the example of the present invention.

FIG. 3 is a schematic sectional view showing a prism sheet used in the example of the present invention.

### DETAILED DESCRIPTION OF THE INVENTION

The present invention is, in a first aspect, to provide a method for producing a continuous sheet having optical functions comprising the steps of:

extruding a melted thermoplastic resin between a continuous release sheet having a three-dimensional pattern having optical functions on its surface and any one selected from a cooling roll with a mirror surface, a cooling roll with an uneven pattern, another release sheet having a three-dimensional pattern or other sheet having optical functions which has a three-dimensional pattern or does not have a three-dimensional pattern,

transferring the three-dimensional pattern of the release sheet and the mirror surface or uneven pattern of the cooling roll or the three-dimensional pattern of another release sheet or the other sheet on a surface of the thermoplastic resin or simultaneously transferring and laminating the other sheet, and

cooling and removing the continuous release sheet, wherein

the release sheet comprises a curable resin on which a three-dimensional pattern having the optical functions is formed, and a change in a surface-gloss of a layer on which the three-dimensional pattern is formed, is not more than 30% in pressing a hot plate heated to 160° C. under a force of 20 kg/cm² for 3 seconds and the release sheet may be wound in a form of cylinder of not more than 12 inches in diameter.

The present invention is, in a second aspect, to provide a method for producing a continuous sheet having optical functions comprising the steps of:

extruding a melted thermoplastic resin between a continuous release sheet having a three-dimensional pattern having optical functions on its surface and any one selected from a cooling roll with a mirror surface, a cooling roll with an uneven pattern, another release sheet having a three-dimensional pattern or other sheet having optical functions which has a three-dimensional pattern or does not have a three-dimensional pattern,

transferring the three-dimensional pattern of the release sheet or mirror surface or uneven pattern of the cooling roll or the three-dimensional pattern of another release sheet or the other sheet on a surface of the thermoplastic resin or simultaneously transferring and laminating the other sheet,

cooling and removing the continuous release sheet, wherein

the release sheet comprises a composite release sheet composed of a curable resin on which a three-dimensional pattern having the optical functions is formed, and a substrate and a change in a surface-gloss of a layer on which the three-dimensional pattern is formed, is not more than 30% in pressing a hot plate heated to 160° C. under a force of 20 kg/cm² for 3 seconds and the release sheet may be wound in a form of cylinder of not more than 12 inches in diameter.

Generally, it is difficult to obtain a sheet provided with a precise three-dimensional pattern in succession directly from a metallic roll for forming patterns. Previously, the present inventors have found out that a method for transferring a pattern on a thermoplastic resin having proper properties by using a release sheet of a thermoplastic resin having a precise three-dimensional pattern is most effective to obtain a continuous sheet with optical functions (Japanese Patent No.2,925,069, U.S. Pat. No. 5,885,490 described above).

It has been understood that it is possible to obtain a release sheet having a precise three-dimensional pattern, which may provide optical functions, by selecting a resin having the good ability for forming patterns faithfully according to a metal die and the proper releasability even though the resin is somewhat inadequate to the optical characteristics and other characteristics required and by selecting a method balanced between the ability for forming patterns and the releasability to obtain a release sheet having a precise three-dimensional pattern from a metallic roll.

As the release sheet of a thermoplastic resin, polyesters such as non-crystalline polyester and polybuthylene terephthalate, and polyolefins such as polyethylene, polypropylene and poly (4-methylpentene-1) are exemplified. The thermoplastic resin is favorable in that the release sheet of a thermoplastic resin may be produced in the process similar to the following process of producing resinous optical products of a thermoplastic resin. However, in this method, it is important to select a resin having a heat resistance standing a temperature at which the following transcription of a pattern on a layer of a thermoplastic resin is conducted, and a kind of the thermoplastic resin and processing conditions are limited.

In view of the situation, to overcome the above defects, it was considered to utilize resin compositions capable of being cured by heat or light as a release sheet, and therefore it has been found that it is significant for a release sheet to stand a force applied to be pressed between a cooling roll and a rubber press roll for transcription and to stand paying-out, winding and removing force upon removing the release sheet. Therefore, mechanical strength of a curable resin release sheet such as tensile strength, elongation and flexibility are required, and especially the ability of the release sheet to be wound in a certain curvature is important which allows the objective continuous sheet to be realized. As the curvature, it has been found that a diameter of 12 inches is a boundary line. That is, it is required that when a release sheet is wound in a form of cylinder of 12 inches in diameter, fine cracks and breaks do not occur. That is, when cracks and breaks occur in winding a release sheet in a diameter of 12 inches or more, the release sheet is insufficient, and even when cracks and breaks occur for a diameter of 12 inches or less, the release sheet may be used. Of course, it is furthermore sufficient when cracks and breaks do not occur even for a diameter of 12 inches or less.

Transcriptional ability through extrusion lamination of a thermoplastic resin on a release sheet depends largely on the heat resistance of the release sheet. This heat resistance means the properties that a release sheet itself does not contract or deform due to extrusion lamination and that a formed three-dimensional pattern having optical functions does not change. Since the latter is associated with a fine three-dimensional pattern for providing optical functions, the former deformation of a release sheet itself does not occur without the latter deformation. Accordingly, the performance may be evaluated based on the presence or absence of a change in three-dimensional pattern. Since the three-dimensional pattern having optical functions depends on only a surface of a release sheet, the performance may be known by a change in optical characteristics of the surface. As a simple method, a degree of the change in optical characteristics of the surface before and after thermal deformation may be determined by measuring reflected light of light entering at a specified angle by a glossmeter.

In extrusion lamination of a thermoplastic resin conducted in succession, extrusion is conducted, in most cases, at a resin temperature of 250° C. or more though it varies a little depending on a kind of resin. Recently, resins with a high refractive index are often used, and a further higher temperature is used in this case. However, since it is known that the surface temperature of a release sheet at the moment when the resin extruded contacts with the surface of the release sheet is lower by 80° C. to 90° C. than the resin temperature around a die through the measurement by a thermochromic paper and the like, the temperature is generally about 160° C. and it is practically sufficient to take 180° C. as the surface temperature. On the other hand, a condition of a press pressure in laminating becomes 20 kg/cm² from the state in which a rubber roll is pressed against a metallic roll for cooling and from the contacting area size, and a contacting time is one second or less.

In a heat resistance test by a method of pressing a hot plate heated in the similitude of laminating conditions, a test machine used for the test of a heat seal is suitable. In this machine, upper and lower hot plates respectively controlled in temperature are pressed under a specified pressure for a definite period of time, and then these plates are released. When comparing a laminating machine and a heat seal pressing machine, one second of pressing time of a heat seal pressing machine may cause the variation of heat transfer and therefore it is considered taking 3 seconds of pressing time as a standard. Therefore, it has been found that the surface temperature of the release sheet becomes higher by about 20° C. than that in measurements by a thermochromic paper or in a laminating test. Accordingly, by setting the hot plate temperature of the heat seal pressing machine at 160° C. being lower by 20° C. than 180° C. described above, the temperature condition becomes similar to that in laminating and it may be considered substantially as the same. That is, the performance of the curable resin release sheet may be grasped by observing the change in a gloss of the surface when the hot plates heated to 160° C. are pressed against a layer formed with a pattern under a force of 20 kg/cm² for 3 seconds. This method is in accordance with a surface heat resistance test of a test method of a thermosetting resin decorative laminated sheet(JIS K6902).

Optical characteristics of plastics, according to JIS K7105, are expressed by a relative value of a gloss of light of an incident angle of 60° to 100% of a gloss of a glass surface. Though this value varies according to optical patterns, kinds and transparency and opaqueness of materials, since this value varies only according to a change in a state of a surface in the same material, a change of a surface may be known by measuring a change in gloss before and after a surface heat resistance test. For instance, in the case of a sheet in a prism form, an incident light close to the normal to a inclined face of a prism goes straight, and a high value of a gloss is apt to be obtained since the light is reflected all on the backside and exits when a sheet is transparent. When the inclined face of a prism is deformed by the surface heat resistance test, a gloss is apt to decrease greatly. Accordingly, when the inclined face of a prism changes by 30%, optical characteristics changes by 30% or more, and this is not adequate.

The curable resin includes unsaturated polyester resins, epoxy resins, urethane resins, acrylic resins and silicone resins. A few compounds of unsaturated polyesters satisfy both of the heat resistance and the flexibility, and compounds containing vinyl esters and esters with a terminal acrylic group are preferred. Epoxy resins are promising though they have a defect in releasability from a metallic embossing roll. They are particularly properties-adjustable by selecting a kind of a curing agent. In urethane resins, heat resistant molded articles are obtained by adjusting a kind and composition of isocyanate and polyol. In curable acrylic resins, there are many useful resins cured by electron beam and ultraviolet ray. In silicone resins, there are many resins which are noted as mold materials and though heat resistance resins exist depending on a kind, there are few kinds of resins which indicate the heat resistance as a release sheet. In these curable resins, resins cured by heat, ultraviolet ray or electron beam are included. These may be used singly or in combination of two or more.

Generally, in a case of a single-layer sheet of a curable resin composition, when it satisfies the condition of the temperature of thermal surface deformation, it is apt to become impossible to wind the sheet in a form of cylinder of 12 inches in diameter and, on the other hand, when it is possible to wind the sheet in a form of cylinder of 12 inches in diameter, the temperature of thermal surface deformation is apt to lower. As the curable resin composition which is high in temperature of thermal surface deformation and which is possible to be wound as a sheet in a form of cylinder of 12 inches in diameter, it is preferable to use an epoxy resin with a special composition of vinyl esters or a special silicone resin. Further, a polymerizable acrylic prepolymer containing, as a skeleton, polyester, polyurethane, epoxy and polyether and having an acryloyl group as a functional group provides a light-curable composition having heat resistance and the ability to be wound as a sheet. Though an arbitrary thickness of a release sheet of these curable resin compositions may be adopted, the thickness of a range of 50 to 300 μm is usually used and the sheet in a range of 100 to 200 μm is easy to be wound up.

The release sheet of a curable resin is made by applying a curable resin on a metallic embossing roll with a three-dimensional pattern having optical functions on its surface or on a thermoplastic sheet on which a three-dimensional pattern is formed, obtained by extruding the melted thermoplastic resin on this embossing roll, and curing the curable resin by heating or irradiating light such as ultraviolet ray and electron beam, then removing the cured resin from the metallic embossing roll or the thermoplastic sheet patterned.

Compared with this, in the case of a composite sheet, many suitable release sheets may be found. That is, as a substrate a synthetic resin film or sheet, a metallic foil, a cloth, a nonwoven fabric and paper are included. It is easy to wind a substrate in a form of cylinder of 12 inches or less in diameter, and it is easy to overlay a curable resin being capable of satisfying the thermal deformation temperature on the substrate into a composite layer. The substrate is required not to contract or deform in the following extrusion lamination of a thermoplastic resin and not to affect the formation of a three-dimensional pattern due to the uneveness on its surface, and a synthetic resin or a metallic foil is suitable.

As the substrate sheet of a synthetic resin, sheets of heat resistant engineering resins such as polyolefin, polyester, polycarbonate, polysulfone, polyphenylene sulfide and polyether-ether-sulfone may be exemplified. Particularly preferable sheet is a biaxially orientated polyester sheet. As the metallic foil, aluminum foil may be named.

The curable resin to be used for a composite release sheet may be widely selected from curable resins described above. Preferably, a light-curable resin is suitable, as in a single-layer of a curable resin composition. As the most suitable example, a composite sheet obtained by overlaying a light-curable resin composition having formed a pattern on a biaxially orientated polyester sheet is exemplified. The composite release sheet is obtained by applying a curable resin on a metallic embossing roll having optical functions or on a thermoplastic sheet on which a three-dimensional pattern is formed, obtained by extruding the melted thermoplastic resin on this embossing roll, and overlaying a substrate on the applied curable resin, or by applying a curable resin on a substrate and overlying it on a roll for forming a pattern or a thermoplastic sheet on which a pattern is formed, and curing the curable resin by heating or irradiating light, then, removing the roll for forming a pattern or the thermoplastic sheet patterned. In this case, to enhance the adhesion between the substrate and the curable resin layer, when a substrate is a thermoplastic sheet, the surface of the substrate may be subjected to a corona discharge treatment or a oxidation treatment or may be applied with an adhesive.

Though the thickness of the substrate of the composite release sheet is arbitrary, the thickness of a range of 50 to 300 μm is usually used, preferably, a range of 75 to 200 μm is used. The layer of the curable resin composition overlaid on the substrate is required only to have a thickness which allows a desired three-dimensional pattern to be formed most faithfully. The thickness of the layer usually falls in a range of 25 to 200 μm and generally, the thinner, the better. It is proper that a ratio of the thickness of the curable resin composition layer on which a three-dimensional pattern is formed and to the thickness of a thermoplastic resin layer as a substrate is 1/10 to 2/1, but it is preferred that this ratio is 1/6 to 1/1 to satisfy the heat resistance and the flexibility.

The three-dimensional pattern is directly related with the optical functions of the continuous sheet. As such patterns, there are included those of a prism type being in section isosceles triangles different in apex angle and scalene triangles somewhat slanted, arranged in series, or large and small triangles in section arranged in series, a wavy type in repeated sines in section, a lenticular lens type in repeated downward semispheres, a lens array type in mixed pyramids and downward semispheres etc. in section, and uneven patterns creating appearance such as a matte pattern, a semi-matte pattern, a linear pattern, a mesh-like pattern and a micro-uneven pattern. In cases where a three-dimensional pattern is of shallow unevenness or low transfer precision, direct transfer from the embossing roll is feasible, hence there is no particular reason for using a release sheet.

The thermoplastic resin to which a three-dimensional pattern is transferred may, as a rule, be good if it has a sufficient thermoplasticity, and there are included polyesters like polyethylene terephthalates, polybutylene terephthalates and polyethylene naphthalates (including their copolymers), polyamides, polycarbonates, polyarylates, polyethersulfones, and acrylic polymers such as polymethylmethacrylates, polystyrenes, and polyolefins such as polypropylenes, poly-4-methylpentene-1 and non-crystalline cyclic polyolefins. For further improving optical functions, required are higher transparency, higher refractive index and improved environmental capability, hence non-crystalline heat-resistant polyesters, polycarbonates and its copolymers or transparent blends, acrylic polymers such as polyme thylmethacrylates, and non-crystalline cyclic polyolefins are preferred.

The aforementioned thermoplastic resin is extruded into the space between a continuous release sheet having a three-dimensional pattern in its surface and a cooling roll in contact with the reverse side thereof, and pressure is applied by a press roll (rubber roll) from the reverse side of the release sheet and the repetition patterns are formed on both sides thereof. The surface of the cooling roll is provided with an uneven pattern or is mirror-like. When it is mirror-like, the sheet obtained has one side thereof smooth and has optical functions on the other side, and a continuous sheet having optical functions such as prism sheets, lenticular lens sheets, lens arrays and anti-dazzling sheets are obtainable. Meanwhile, when the surface of the cooling roll is of a matte pattern, a semi-matte pattern, a linear pattern, a mesh-like pattern or a micro-uneven pattern, it is often the case that no high precision is required, and transfer from direct embossing roll is feasible. Since, in this case, optical functions are possibly imparted to both sides of a sheet, a continuous sheet with complex optical functions such as anti-dazzling prism sheets or optical diffusion prism sheets are obtained.

It is also possible to put the aforementioned thermoplastic resin between two kinds of continuous release sheets and to have one side thereof pressed by a metal roll and the other side by a rubber roll to thus impart different patterns to both sides thereof for different optical functions. The combination may be of the same kind or of different kinds. In the latter case, either of two kinds of the release sheets may possibly be pattern-free (smooth). When two kinds of the release sheets are used, the combination of at least one kind being a release sheet of a curable resin, the other being a release sheet of a thermoplastic resin or other materials may be exemplified.

In the case of combination of the same kind, taking a prism sheet, for example, the longitudinal directions of the repetition of prisms may be the same on both sides. It is also possible to have them intersected perpendicularly or at a given angle. It is naturally possible to combine rows of prisms different in size.

For obtaining a simultaneously transferred and laminated sheet of a light-transmitting base sheet and a thermoplastic resin sheet having a three-dimensional surface pattern, a so-called sandwich lamination method is used in which a light-transmitting sheet is fed from one side and a three-dimensionally patterned continuous release sheet from the other side and a thermoplastic resin is extruded into therebetween.

By this method, it is possible to impart the properties of the light-transmitting sheet to the optically functional sheet thus formed. For example, it is possible to impart to the continuous sheet transparency, such mechanical properties as tensile strength and elongation as well as heat resistance and environmental capability (dimension stability).

As the light-transmitting base sheet, there is no particular limitation if it only has a heat resistance enough to withstand the temperature at which a three-dimensional pattern is imparted to the base sheet, and there are included synthetic resin sheets such as polyesters like polyethylene terephthalates, polybutylene terephthalates and polyethylene naphthalates, polyamides, polycarbonates, polyolefin-type synthetic resins such as polypropylenes, poly-4-methylpentene-1 (TPX) or laminated sheets thereof. Of these, particularly suitable is a biaxial orientated polyethylene terephthalate film. Further, lamination can be enhanced by such surface treatment as anchor coating and corona treatment.

When an optical function base sheet is used instead of a light-transmitting base sheet, a laminated sheet having combined therein an optical function and another optical function imparted by a three-dimensional pattern is obtained. In this case as well, the base sheet is required to be heat resistant enough to withstand the temperature at which a three-dimensional pattern is transferred. As such examples, there are included a polarized film of polyvinyl alcohol type, a polarized sheet admixed with various dyes, a phase difference film and an anti-dazzling sheet already known as optically functional sheets. If necessary, it is also possible to use a sheet with the aforementioned three-dimensional pattern on one side and laminate to the other side thereof a sheet having another three-dimensional pattern and in this way a sheet having compounded optical functions can be produced by lamination. In this case, the two sheets may possibly be of the same kind or of different kinds. In the latter case, a surface treatment such as anchor coating or corona treatment is in most cases considered suitable.

A continuous sheet having an optical function imparted by the formation of a three-dimensional pattern of the present invention which is obtainable by melt-extrusion of a continuous release sheet having a three dimensional pattern has its optical function itself being continuous, hence, it is freely cuttable in any desired size and form, thus having a high producibility and yield.

The present invention will be described below in greater detail by way of examples, but the present invention is not limited thereby.

### EXAMPLE 1

### Production of Release Sheets

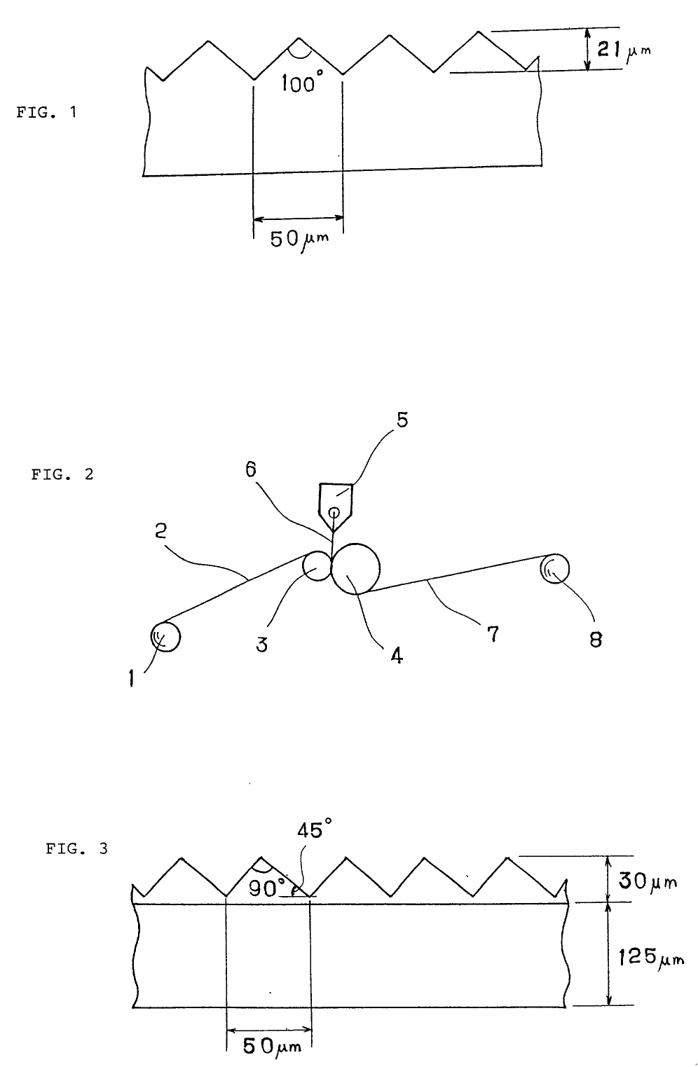

By extruding poly (4-methylpentene-1) being a thermoplastic resin from a die in a coat hanger form at a temperature of 280° C. on a embossing roll, having in the circumferential direction of a metallic roll of 250 mm in diameter, three-dimensional pattern having the performance of a prism which is an isosceles triangle with a base length of 50 μm, a base angle of 40° and an apex angle of 100° in cross section and of which base edges are adjacent, as shown in FIG. 1, and by pressing with a rubber roll under a facial pressure of 20 kg/cm² and forming a pattern on the sheet, a thermoplastic release sheet (A) of 230 μm in thickness was obtained.

Then, “Desolite KZ9699 (trade name)” of JSR Corp., an ultraviolet ray-curable resin of urethane acryl type, was applied on this thermoplastic release sheet (A) with a bar coater, and after the curing resin was irradiated with a 120 W metal halide lamp of a conveyor-type ultraviolet ray irradiation apparatus, “GS 60L (trade name)” of Japan Storage Battery Co., Ltd., for nine seconds to be cured, the thermoplastic release sheet (A) was removed and a curable resin release sheet (B) of 180μm in thickness having a continuous three-dimensional pattern was obtained.

Furthermore, in producing a curing resin release sheet (B) as mentioned above, after applying an ultraviolet ray-curable resin in the thickness of 40μm on the thermoplastic release sheet (A), a biaxially orientated polyethylene terephthalate sheet, “Emblet SA125 (trade name)” of Unitika Ltd., 125 μm in thickness as a substrate was overlaid so that the surface of the substrate which was subjected to corona discharge treatment was contacted with the applied curable resin layer, and after curing the curable resin layer in the same way as in producing the curable resin release sheet (B), the thermoplastic release sheet (A) was removed and thus a composite curable resin release sheet (C) consisting of the curable resin layer having a three-dimensional pattern and the biaxially orientated polyethylene terephthalate substrate was obtained.

### Production of Resinous Optical Sheets

As shown in FIG. 2, each release sheet (2) of three kinds of release sheets (A), (B) and (C) obtained above, which were rolled into a cylindrical form with a diameter of 6 inches, was fed from a feeder (1) to the side of a press roll (rubber roll) (3) for pressing in an extrusion laminator (5) having a T-shaped die (screw diameter 40 mm, L/D=22), and between the press roll (3) for pressing and a cooling metallic roll (4) having a random pattern of fine uneveness, a melted polycarbonate (6), “Panlite L1225ZE (trade name)” of Teijin Ltd., was extruded from the die in a coat hanger form, varying a resin temperature with two levels. Pressing pressure of the press roll was kept at 20 kg/cm² and a three-dimensional pattern was transferred on the polycarbonate sheet (6) at an operating speed of 10 m/min. The obtained resinous optical sheet (7) was bonded with a protective film to protect its optical functions and wound by a winder (8) after the release sheet was removed.

The characteristics of the release sheet and the resinous optical sheets were evaluated in a method below, and the results are shown in Table 1.

### Evaluation of Characteristics of the Release Sheets

Flexibility by the roll diameter:

When these release sheets are rolled in a cylindrical form with three-dimensional patterns having optical functions faced outside, the roll diameter not causing breaks and cracks was investigated.

Heat resistance test of a surface by a heat seal tester:

Using “SG Sealer (trade name)” of Shiga Packaging Machinery Co., Ltd., with three-dimensional patterns having optical functions faced outside, a movable upper side (the side contacting with a three-dimensional pattern) hot plate was heated and controlled at 160° C. and pressed against three-dimensional patterns under a pressing pressure of 20 kg/cm² for three seconds, and then the change of a gloss of the pressed location on the incident light with 60° of angle was investigated.

### Evaluation of Characteristics of the Resinous Optical Sheets

Prism function:

A prism sheet has an ability of condensing light in the direction perpendicular to an emitting surface corresponding to an inclined face of a prism, when the prism sheet is installed onto a plane-emitting device (back light) involving scattering. However, when an inclined face of the prism is bent or deformed, light is not condensed in the perpendicular direction. And, when two prisms are overlaid with two longitudinal edges of each prism orthogonal to each other, the ability of condensing light is enhanced. Utilizing this, the prism functions are evaluated.

Plane-emitting device:

Dot printing is applied on a backside of a wedge-shaped optical guide plate of 92 mm in length and 158 mm in width provided with a cold cathode tube on the thicker side face to scatter light and a reflector is provided on the outside of the backside. And, the surface is a face through which light exits and a diffusion plate (D121, of Tsujiden Co., Ltd., trade name) is provided on this face. A prism sheet is installed onto the face in such a way that a three-dimensional pattern forms a face of light exiting. When two prism sheets are overlaid, they are arranged in such a way that each longitudinal edge of the prism sheets is orthogonal to each other.

Measuring of brightness:

The brightness of three locations of a central position of the back light, a closer position by 25 mm from the central position to the cold cathode tube and a far position by 25 mm from the central position to the cold cathode tube are measured at the location with a distance of 60 cm using a “Luminance calorimeter BM5A (trade name)” of Topcon Corp. as a measuring apparatus and the measurements of three locations are averaged, and the ratio of brightness to that of the case not using a prism are determined.

Sectional configuration of a prism:

A specimen prepared by slicing a prism sheet in the direction perpendicular to a longitudinal edge of the prism is covered with an acrylic embedding agent to be solidified, and the sectional face of the specimen solidified is sliced and honed to be observed by a microscope. A three-dimensional pattern of the release sheet and a three-dimensional pattern transferred on the resinous optical sheet are compared and the accuracy of transcription is investigated. Particularly, a degree of a rate of a straight portion of a prism inclined face existing and the conditions of a convex portion and a concave portion (angle sharpness) of the prism are observed.

TABLE 1

| Kind of release sheets | | | Thermoplastic release | | Curable resin | | Composite release | |
|---|---|---|---|---|---|---|---|---|
| (Apex angle 100°) | | | sheet (A) | | sheet (B) | | sheet (C) | |
| Evaluation | Flexibility by a roll diameter | | Windable practically | | Break at 6-inch | | Windable even at | |
| of release | | | at any diameter | | diameter | | 3-inch diameter | |
| sheets | Surface heat resistance test | | | | | | | |
| | Gloss before test (a) | | 92.7 | | 314.0 | | 335.0 | |
| | Gloss after test (b) | | 72.6 | | 331.0 | | 330.0 | |
| | Rate of change (%) * | | 21.7 | | 5.4 | | 1.5 | |
| Evaluation | Temp. of extruded resin (° C.) | | 285 | 310 | 285 | 310 | 285 | 310 |
| of resinous | Brightness of back lite | | | | | | | |
| optical | One sheet:Increase rate (fold) | | 1.45 | 1.42 | 1.47 | 1.50 | 1.47 | 1.51 |
| sheets | Two sheets:Increase rate (fold) | | 1.72 | 1.61 | 1.74 | 1.78 | 1.74 | 1.79 |
| | Sectional | Straight portion | 93 | 87 | 94 | 99 | 94 | 100 |
| | configuration | of an inclined | | | | | | |
| | of a concavo- | portion (%) | | | | | | |
| | convex portion | Convex portion | Apex angle | Apex angle | Apex angle | Apex angle | Apex angle | Apex angle |
| | of prism | | is curved. | is | is | is | is | is clearly |
| | | | | indicated. | somewhat | indicated. | somewhat | indicated |
| | | | | | curved. | | curved. | |
| | | Concave portion | Sharp | Greatly | Sharp | Sharp | Sharp | Sharp |
| | | | angle is | curved | angle is | angle is | angle is | angle is |
| | | | indicated. | angle is | indicated. | indicated | indicated. | clearly |
| | | | | indicated. | | | | indicated. |

* [(a) − (b) / (a) ] × 100

As apparent from Table 1, when polycarbonate is adopted as resinous optical sheets, a higher temperature of extrusion processing provides a better transcriptional ability and a higher performance prism. However, in a thermoplastic release sheet, the performance decreases in processing at a higher temperature and this results from the deformation of the release sheet. Accordingly, it is understood that a thermoplastic release sheet is limited with respect to processing (temperature) range and is inferior in transcriptional ability compared with a curable resin release sheet.

### EXAMPLE 2

As shown in FIG. 3, by joining with an heat resistant adhesive tape, commercially available prism sheets, each comprising a prism sheet consisting of a curable resin (30 μm), in which a three-dimensional pattern having optical functions is a right angled isosceles triangle with a base length of 50 μm, a base angle of 45° and an apex angle of 90° in cross section and base edges are adjacent and a biaxially orientated polyethylene terephthalate (125 μm) layer, a composite curable resin release sheet (D) was obtained. The three-dimensional pattern of the release sheet was transferred to polycarbonate by a method similar to Example 1 and the characteristics of the release sheet and the obtained resinous optical sheet were evaluated. Evaluation results are shown in Table 2.

TABLE 2

| Composite release sheet (D) | | | (Apex angle 90°) | |
|---|---|---|---|---|
| Evaluation | Flexibility by a roll diameter | | Windable even at | |
| of release | Surface heat resistance test | | 3-inch diameter | |
| sheet | Gloss before test (a) | | 354.0 | |
| | Gloss after test (b) | | 352.0 | |
| | Rate of change (%)* | | 0.6 | |
| Evaluation | Temp. of extruded resin (° C.) | | 285 | 310 |
| of resinous | Brightness of back lite | | | |
| optical | One sheet: Increase rate (fold) | | 1.52 | 1.56 |
| sheet | Two sheets: Increase rate (fold) | | 1.86 | 1.92 |
| | Sectional | Straight portion | 94 | 100 |
| | configuration | of an inclined | | |
| | of a concavo- | portion (%) | | |
| | convex portion | Convex portion | Apex | Apex |
| | of prism | | angle is | angle is |
| | | | somewhat | clearly |
| | | | curved, | indicated. |
| | | Concave portion | Sharp | Sharp |
| | | | angle | angle |
| | | | is | is |
| indicated. | clearly | | | |
| | | | | indicated. |

*[(a) − (b)/(a)] × 100

As apparent from Table 2, it is understood that when commercially available prism sheets are jointed continuously, they may be used as a curable resin release sheet.

As described above, in accordance with the present invention, it is possible to enhance a degree of freedom of processing conditions and thermoplastic resins to be used and to produce a continuous sheet having high performance optical functions efficiently.

What is claimed is:

1. A method for producing a continuous sheet having optical functions comprising the steps of:
extruding a melted thermoplastic resin between a continuous release sheet having a three-dimensional pattern having optical functions on its surface and any one selected from a cooling roll with a mirror surface, a cooling roll with an uneven pattern, another release sheet having a three-dimensional pattern or other sheet having optical functions which has a three-dimensional pattern or does not have a three-dimensional pattern,
transferring the three-dimensional pattern of the release sheet and the mirror surface or uneven pattern of the cooling roll or the three-dimensional pattern of another release sheet or the other sheet on a surface of the thermoplastic resin or simultaneously transferring and laminating the other sheet, and
cooling and removing the continuous release sheet, wherein
the release sheet comprises a curable resin on which a three-dimensional pattern having the optical functions is formed, and a change in a surface-gloss of a layer on which the three-dimensional pattern is formed, is not more than 30% in pressing a hot plate heated to 160° C. under a force of 20 kg/cm² for 3 seconds and the release sheet may be wound in a form of cylinder of not more than 12 inches in diameter.

2. A method for producing a continuous sheet having optical functions comprising the steps of:
extruding a melted thermoplastic resin between a continuous release sheet having a three-dimensional pattern having optical functions on its surface and any one selected from a cooling roll with a mirror surface, a cooling roll with an uneven pattern, another release sheet having a three-dimensional pattern or other sheet having optical functions which has a three-dimensional pattern or does not have a three-dimensional pattern,
transferring the three-dimensional pattern of the release sheet or mirror surface or uneven pattern of the cooling roll or the three-dimensional pattern of another release sheet or the other sheet on a surface of the thermoplastic resin or simultaneously transferring and laminating the other sheet, and
cooling and removing the continuous release sheet, wherein
the release sheet comprises a composite release sheet composed of a curable resin on which a three-dimensional pattern having the optical functions is formed, and a substrate and a change in a surface-gloss of a layer on which the three-dimensional pattern is formed, is not more than 30% in pressing a hot plate heated to 160° C. under a force of 20 kg/cm² for 3 seconds and the release sheet may be wound in a form of cylinder of not more than 12 inches in diameter.

3. A method for producing a continuous sheet having optical functions as set forth in claim 1 or 2, wherein the other sheet to be simultaneously transferred and laminated is a light-transmitting base sheet or an optical function base sheet.

4. A method for producing a continuous sheet having optical functions as set forth in claim 1 or 2, wherein the three-dimensional pattern of the continuous release sheet having optical functions is formed by a metallic embossing roll or a thermoplastic sheet on which a pattern is formed by extruding a melted thermoplastic resin on a metallic embossing roll.

5. A method for producing a continuous sheet having optical functions as set forth in claim 1 or 2, wherein the curable resin is a light-curable resin.

6. A method for producing a continuous sheet having optical functions as set forth in claim 2, wherein a ratio of the thickness of the layer on which a three-dimensional pattern of the composite release sheet having the optical functions to that of the substrate is 1/10 to 2/1.

7. A method for producing a continuous sheet having optical functions as set forth in claim 2, wherein the substrate of the composite release sheet is a sheet of a biaxially orientated polyethylene terephthalate.
